(19) United States
(12) Patent Application Publication
(10) Pub. No.: US 2022/0223067 A1
(43) Pub. Date: Jul. 14, 2022

(54) SYSTEM AND METHODS FOR LEARNING AND TRAINING USING COGNITIVE LINGUISTIC CODING IN A VIRTUAL REALITY ENVIRONMENT

(71) Applicant: Rubicon Elite Performance, Inc., Kenmore, WA (US)

(72) Inventors: Dutch Franz, Seattle, WA (US); Robert Macmillan Seed, Mýto pod ?umbierom (SK)

(21) Appl. No.: 17/612,397

(22) PCT Filed: Jun. 3, 2020
(86) PCT No.: PCT/US2020/035916

§ 371 Date: Nov. 18, 2021

Related U.S. Application Data
(60) Provisional application No. 62/857,978, filed on Jun. 6, 2019.

(51) Int. Cl. G09B 19/04; G09B 5/06; G06F 3/01

(52) U.S. Cl. CPC G09B 19/04; G06F 3/012; G06F 3/013; G09B 5/065

(57) ABSTRACT

A system and method for providing an immersive environment is described herein. The immersive environment, such as virtual reality or augmented reality, can be used to develop a trainee's ability to make decisions through a language-based comparison process. Cognitive linguistic coding, including brevity coding, can be used by the trainee to develop, reinforce, or enhance alignment and mapping between structured conceptual representations. The immersive environment can simulate or emulate an actual environment in which a task is to be performed.

### CROSS-REFERENCE TO RELATED APPLICATIONS

This application claims the benefit of pending U.S. Provisional Application Ser. No. 62/857,978, filed Jun. 6, 2019, the contents of which are hereby incorporated by reference in their entirety.

### BACKGROUND

Preparing someone to accomplish a task or helping them to learn or become more proficient at a skill often requires repetition and some form of training. This training process can be for purposes of learning to do a complicated task, preparing for an exam, or other complex behavior. During the training process, a person can be exposed to a set of stimuli and then expected to recognize and properly respond to those stimuli. The stimuli can represent a situation in which the person can be placed during an activity, for example.

It is generally believed that more effective learning can be obtained from a training process that closely resembles the actual situation or environment in which a person is expected to demonstrate the skill or accomplish the task. This makes intuitive sense, as, for example, studying for a test and taking practice tests in a similar environment and under similar conditions as an actual test seems to improve outcomes by reducing the differences between the practice environment and the actual text environment.

What is needed is a more efficient and effective system for teaching and learning.

### BRIEF DESCRIPTION OF THE DRAWINGS

FIG. 1 illustrates an example 3-dimensional (3-D) training environment.

FIG. 2A illustrates an example flowchart for implementing a situational evaluation training system.

FIG. 2B illustrates an example block diagram for a defining module.

FIG. 2C illustrates an example block diagram for a conducting module and a reviewing module.

FIG. 3 illustrates an example process for brevity code capture and grading.

FIG. 4 illustrates an example markup editor (MUE).

FIG. 5 illustrates an example system including a model view controller and computer design pattern.

FIG. 6 illustrates an example platform.

FIG. 7 illustrates an example device or system.

### DETAILED DESCRIPTION

Cognitive linguistic coding and virtual reality (VR) or augmented reality (AR) can be used to develop a trainee's ability to make complex decisions through a language-based comparison process in an immersive life-like environment. The process develops, reinforces, or enhances the alignment and mapping between structured conceptual representations for the trainee.

VR or AR can be useful in simulating or emulating an actual environment in which a task is to be performed because of the ability to create an immersive, life-like environment for the trainee. To make the technology most useful to learning and skill development, the VR or AR can be implement to be a functional equivalent (or almost one) of the elements or situation of a task in both the virtual environment and in the real environment that the trainee co-inhabits with the virtual environment.

To use a virtual environment to train the neurocognitive networks associated with a particular skill and develop a trainee's ability to perform a task at a high level, the trainee undergoes the same or substantially the same experience as the trainee would in the actual situation. This includes, but is not limited to, wearing what the trainee wears during performance of the task, standing or sitting how the trainee does during performance of the task, holding or engaging with the same object that the trainee does during performance of the task, and saying or moving (to the extent possible) as the trainee would during performance of the task. For example, a quarterback can grip a football, wear pads, or both, while undergoing training

The trainee interacts with the virtual environment, rather than passively watching, and makes decisions and experiences outcomes associated with those decisions (or behavior) that the trainee would expect to experience in a real environment. The system can permit the trainee to interact naturally with the virtual environment, to customize performance measures, to allow for review (e.g., audio, visual, or both) concurrent with the review of the graded performance measures.

In one example, a system for assisting in one or more of learning a complex set of motions, decision processes, reactions, evaluation of a situation, recognition of certain factors, etc. can include one or more functionalities or capabilities, including, without limitation, a computer application (or set of computer-executable instructions stored on a non-transient computer-readable medium, routine, module, sub-module, etc.) that allows individuals to embed measurable performance tasks into a virtual reality environment; a computer application that allows trainees to operate in the virtual environment as he/she would in a real environment; make decisions based on emerging dynamic cues, display physical performance behavior, and verbally communicate with the application; capability of using applied voice recognition technology to provide a hands-free engagement within the virtual environment, allowing for the full adoption of functional equivalence training/learning; use of embedded cognitive linguistic coding (the assignment of words to perceived complex relationships and behaviors) in the trainee's task performance or behavior to increase learning, speed up reaction time and improve decision making; introduced a performance grading process that determines and uses a trainee's gaze, verbal response, and response time, among other possible factors, to determine a task or skill performance evaluation or rating; an algorithm or decision process to assess overall performance competency based on the successful completion of critical tasks within and between actual and virtual performance domains; a capability to review the audio/visual playback of a training session while simultaneously displaying the grading sheet for comparison and improved instruction effectiveness; an interactive grading sheet that can be amended and allows for note taking; a set of statistical analysis and evaluation tools within the application that display current performance statistics for the individual trainee and organization; application of artificial intelligence technology such as one or more of Natural Language Generation, Speech Recognition, Machine Learning, Deep Learning, Biometrics, Decision Management, the like, or combinations or multiples thereof to determine individual progression through a training program and in response identify specific behavior that requires additional training and assist in aligning a trainee's progression through a training scenario based on identified individual needs; the like, or combinations or multiples thereof.

Among other things, the present invention can be embodied in whole or in part as a system, as one or more methods, or as one or more devices. Examples of the invention can take the form of a hardware-implemented example, a software implemented example, or an example combining software and hardware aspects. For example, in some examples, one or more of the operations, functions, processes, or methods described herein can be implemented by one or more suitable processing elements (such as a processor, microprocessor, CPU, GPU, controller, etc.) that is part of a client device, server, network element, or other form of computing or data processing device/platform. The processing element or elements are programmed with a set of executable instructions (e.g., software instructions), where the instructions can be stored in a suitable data storage element. In some examples, one or more of the operations, functions, processes, or methods described herein can be implemented by a specialized form of hardware, such as a programmable gate array (PGA or FPGA), application specific integrated circuit (ASIC), or the like. Note that an example of the inventive methods can be implemented in the form of an application, a sub-routine that is part of a larger application, a “plug-in,” an extension to the functionality of a data processing system or platform, or other suitable form. The following detailed description is, therefore, not to be taken in a limiting sense.

In some examples, the system and method described herein incorporate or implement features or functions to integrate cognitive learning coding with VR to enhance learning of complex tasks. These features, functions or capabilities include, but are not limited to: voice recognition and the ability to “tag” geographical spaces in the VR environment (player, space on the field) with a cognitive learning code (e.g., brevity code), and the ability to voice capture code within a tenth of a second and synchronize with the trainee's gaze.

The trainee's perception of the performance environment and frame of reference within that environment is largely modified and understood through cognitive processes interfacing with an individual linguistic mapping. Cognitive linguistic coding can be understood as the assignment of words to perceived complex relationships and behaviors.

A primary goal of linguistically coding specific complex performance behaviors is to improve learning, improve task performance by reducing reaction time and improving decision-making by installing a prescriptive cognitive thinking pattern based on the performance codes, and creating a common performance vocabulary that can be quickly relayed between coaches and trainees, and is contextually deep in meaning.

Cognitive linguistic coding (CLC) is an approach to task execution in dynamic performance environments and teaching complex skills in virtual reality. Traditional beliefs in the conventional training domain, assumed/believed that verbalizing performance in time sensitive situations would require too much time and result in the trainee being unable to perform the critical behavior in the allotted time. Other companies working in this environment use passive models.

Language is a set of tools with which to construct and manipulate representations of a performance environment. Among other features, examples of the system and methods described herein are innovative both their use of linguistic brevity codes (uniform relational encoding) and the application of this encoding methodology to a time-sensitive virtual reality performance training environment.

Cognitive linguistic coding works at the neurocognitive level of mental processing and develops a trainee's ability to make complex decisions through a language-based comparison process that reinforces or enhances the alignment and mapping between structured conceptual representations. At a fundamental level, decisions are made through a series of comparisons (sense of sameness, pattern matching) based on how the situation is represented in the environment, one's experience, and rules governing relationships in the environment. Research has shown this process impacts rapid decision-making and learning in five ways, including (1) highlights perception of salient information; (2) promotes projection of known inferences from one item to the other; (3) constructs a new understanding based on re-representation of salient information to improve comparison inferences and identify representational uniformity; (4) promotes awareness of relevant differences in salient information; and (5) restructures domain understanding to highlight relevant decision points.

Cognitive linguistic coding establishes relational terms that identify and preserve (and help in the retention of) relational patterns that might otherwise be missed or unrecognized as important spatial, causal, conceptual relationships, the like, or combinations or multiples thereof. This use of Cognitive linguistic coding allows for quicker learning, identification, and communication of salient performance behavior. In addition, the efficiency of these relational terms in representing complex concepts and sequences of observations and decisions allows for quicker expression of multifaceted predictions, dichotomous chains of thought, and complex decisions.

The use of brevity codes and relational language, which can improve relational retrieval and decision-making by between 35% and 47%, can also foster the learning, transference, and retention of critical relational patterns of environmental data in four ways. First, creating a formal name or tag for a relational pattern removes it from its initial context, increasing the likelihood that it can be recognized in other situations. Second, hearing a brevity code primes the brain for learning and allows for memory storing of the situation and label, even before the concept is fully understood. This creates the likelihood of comparison across examples and experiences that might not occur in the physical world but increase understanding of the performance concept. Third, cognitive coding can take advantage of label manipulation (the use of language to associate label with larger or related concepts) to influence creative problem solving and perspective-taking during performance tasks. Fourth, cognitive coding allows for the embedding of complex concepts into concrete performance measures that can be transferred within an organization to create a common understanding and language around the concept.

These areas can be trained and optimized within an application by creating a structured controlled environment that allows the embedding of relational language, isolation (dis-example) of the relational pattern for discrete learning and understanding within the performance context, and the transference of the learning to similar and dissimilar performance situations.

The system and method include verbal interactions tied to key complex behaviors that enhance learning and performance in a way that supports already establish neuro-networks and encourages neuroplasticity around desired performance behavior and is reinforced with neurolinguistics connections.

As an example use case for an example of the system and methods described herein, consider the training of a quarterback to recognize and properly respond to formations and movements they observe while executing a play. While there are other use cases for the system and methods described, one that exemplifies the technology and its benefits is the application's use in training a quarterback in American football. The average forward-pass play in American football takes 4.2 seconds and requires the quarterback to make multiple complex decisions based on multiple variables. Verbalizing all the variables that must be considered in just one of the decisions made by a quarterback in this environment averages 20 seconds (see example below).

In this example, the quarterback might say or think, “The first read is the Y receiver, if he is capped pre-snap I check to see if the cornerback bails at the snap, I check the cornerbacks hip angle and if he is flat footed or on the balls of his feet. On the first hitch, if the cornerback continues to cap and the feet are flat and hips square, I shift to the X receiver and check the seam space along the strong-side hash-mark, if the Safety jumps the X receiver, and the seam space is narrowing in relation to the two moving targets and sidelines and safety is able to top, I throw the backside Go route.” Note the complexity and amount of information that a player needs to notice and process in order to make this decision.

Cognitive linguistic coding allows this complex set of observations, analysis and decisions to be distilled into a one to two-word context-rich brevity code that can be spoken, recorded, and graded by the innovative system at the speed of tenths to hundredths of a second. The process of cognitive linguistic coding comes from psycholinguistic theory and requires a depth of expert level knowledge to understand and apply. The theory has largely been studied in developmental learning circles and its application to dynamic decision-rich virtual reality domains is not an obvious or straight-forward application of the scientific principles.

A training application supports one or more training sessions with a virtual reality player to play interactive training material and capture results, a training course editor to manage and mark up training content, and a playback manager. The training application can also permit the trainee and coach to review and playback training sessions and for coaches to conduct remote real-time training with the player and coach in different geographical locations.

An administration application supports trainee, trainee and partner management as well as overall training analysis and reporting. The training application interfaces with this to obtain trainee profile and trainee enrolments as well as to provide individual training results, as well as to share training course definition.

A video management application supports video content management, including version control; storage of all video content, as well as captured training sessions will be centralized here and delivered to individual instances of training applications as required.

A platform architecture defines the technology platforms and includes interfaces that support the application services. The platform architecture can include a training presentation service, such as in VR, which is based on the 3-D platform, such as Unity, that can run on dedicated VR hardware including the VR headset, collectively known as the “VR Training Environment.” The platform architecture can also include a training application, such as in VR, based on a low code development platform, such as OutSystems (i.e., an administration application based on a low-code platform to manage persistence of training courses, training course data, markup data, the like, or combinations of multiples thereof).

The platform architecture can include one or more interfaces (Trainee Profile & Trainee Enrollment to include the user role (e.g. coach or trainee) and trainee course enrollment; Training Course to include training course details; Training Results to include individual training results to support overall analysis; Video Clip & Training Session to include a video clip to be presented in the VR training application of a training session, which is essentially the responses captured for a given mark-up, may be included for training session review; Training Clip Training Session to include a training clip (e.g., a video); and Payment to include payment associated with training course enrolment). The platform architecture can include one or more components, including Training Presentation (i.e., trainee experience of training environment build over the 3-D platform and delivered through a VR headset to create an immersive interactive training environment), Training Application Service (i.e., interfaces between multiple data sources to facilitate training and management), Video Management (i.e., manages source video content to create a method for importing, saving, and working with 3D video files), Training Persistent Service (i.e., establishes persistent data environment to store the training environment in a hosting platform), Voice Recognition (i.e., tags voice and records speech to text interface with a system for text to voice analysis), Administration Services (i.e., interfaces between multiple data sources to facilitate administrative management to interface with training application and persistent data service to manage data transfer and functionality), Admin Persistent Service (i.e., establishes persistent data environment for administrative functions to store administrative data in the hosting platform), Payment Gateway (i.e., ecommerce capability to facilitate purchases of application from website and triggers access to training application), and Web Portal (i.e., interfaces with payment gateway to facilitate application purchases).

For example, an instance of a situational evaluation training system (SETS) Training application service will run on each VR hardware instance, which will involve a PC application that will support a tethered VR headset (e.g., Oculus Rift) or a networked untethered headset (e.g., Oculus GO) running a separate version of the application. The VR Training Environment supports each concurrent trainee session.

The SETS Training application service can retrieve video content from the SETS content management service, with the video content pre-loaded based on environment setup (course selection).

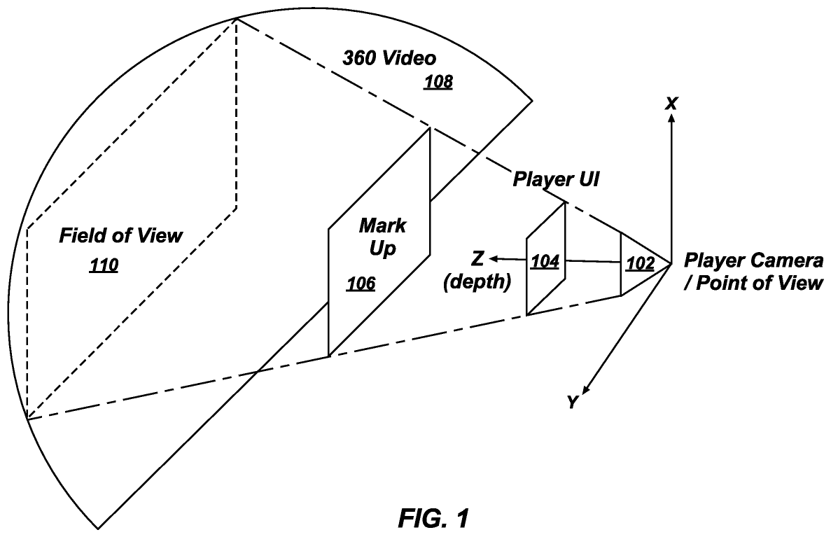

FIG. 1 shows a VR Trainee Interface and Training Environment Overlay. The markup editor, the ability to place performance measures and CLC into the VR environment, is overlaid on the backdrop of VR film. The performance overlay is responsive to the trainee's gaze, performance window, and voice and is anchored and synchronized with the VR background. Gaze can include the direction the trainee's eyes are pointing. Head orientation can include the direction the trainee's head is pointed, tilted, rotated, the like, or combinations thereof.

Though VR is discussed herein for convenience, the immersive environment can be augmented reality (AR).

A camera point of view 102 is the primary direction of camera/trainee. The camera point of view 102 provides a starting point to develop training overlay application.

A player user interface 104 is how a trainee interfaces with the application through the VR headset. The player user interface 104 provides the constraints and foundation of what can be done with the application and how the trainee will interact in the VR performance environment.

A mark-up 106 is a code to overlay performance objectives over a 3-dimensional film clip. The mark-up 106 allows the trainee to interact with the virtual environment.

360 Video 108 is a source content filmed in 360 degrees. The 360 Video 108 is the background video content that serves as the immersive training environment.

A field of view 110 is what the trainee sees through the VR headset. The field of view 110 allows trainee to turn his/her head and engage in or interact with in the full 360 degree performance environment.

Performance is measured in the SETS system through the synchronization of CLC speech, time, and user visual gaze. The mark up 106 is overlaid on the 360 Video 108 in 3D space and synchronized with the video frames displayed over time. The trainee's point of view rotates around an origin, such as by changing gaze or head orientation, and at any point in time the trainee has a limited field of view in which the mark up brevity code can be displayed, hidden, or not present at all.

The system captures speech responses to voice prompts and matches these against the voice prompt text using speech recognition (i.e., speech-to-text translation, via Google's speech to text API and Windows desktop application). The system determines the point in time the speech was started and, once the speech has finished, makes the speech recognition API request to translate to text. Once the API response has been received, the application matches each brevity code to the voice prompt mark up, whether located within the player field of view or hidden, at the time the word was spoken, even if the prompt is no longer active.

In one example, the trainee calls out the correct brevity code, within the allotted timeframe, while looking at the proper place in the field of view to be deemed successful in the task.

In another example, the trainee calls out a comparable brevity code. In other words, the brevity is not identical to the one written by the coach but conveys the same information. The coach can include synonyms into the mark-up or the grading module can perform a brevity code comparison. For example, the coach can set a brevity code as “Check Mike” and the trainee says “55 Mike.” The trainee correctly identified the Mike linebacker (i.e., middle linebacker) but did not say “check.” The trainee can get at least partial credit based on the correct identification.

The data recorded and analyzed by the application is presented in real time using the automated grading systems.

Speech, along with the point of view orientation over time is captured for the training playback, such as by using a .sess file extension that captures video and the embedded voice recording. A training clip recording captures user head movement, voice and responses to MarkUp against video frame position and time, using the TimeFrame entity.

Both session playback and synchronization of a remote (untethered) headset is achieved by the player running the training clip as normal and adjusting the playback based on the captured TimeFrame data. This provides a much more light-weight and interactive way (since playback via the same world environment) than non-interactive video stream that also requires significant bandwidth to transfer between networked devices.

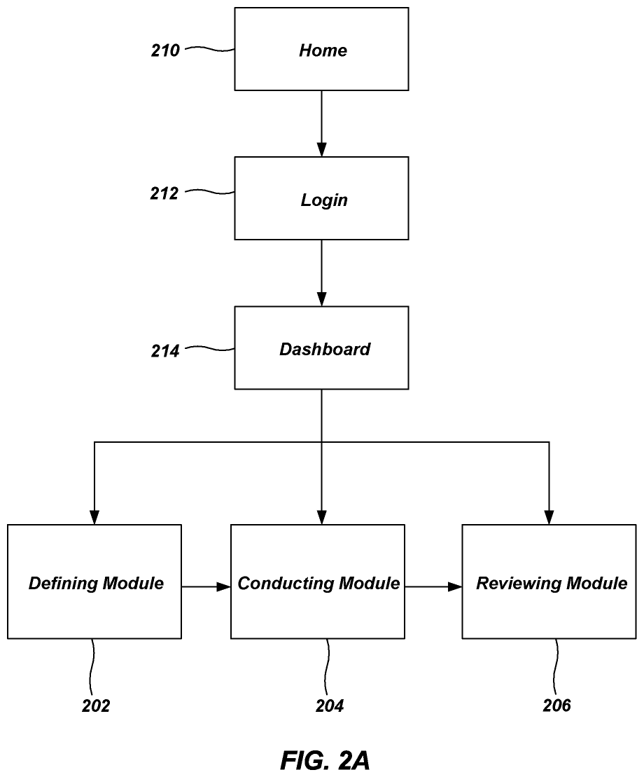

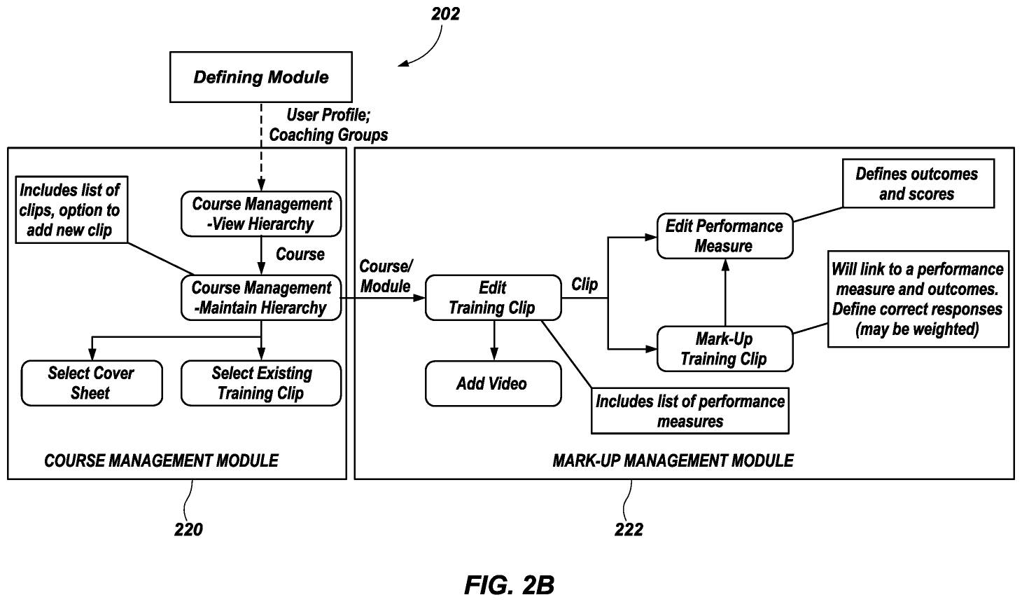

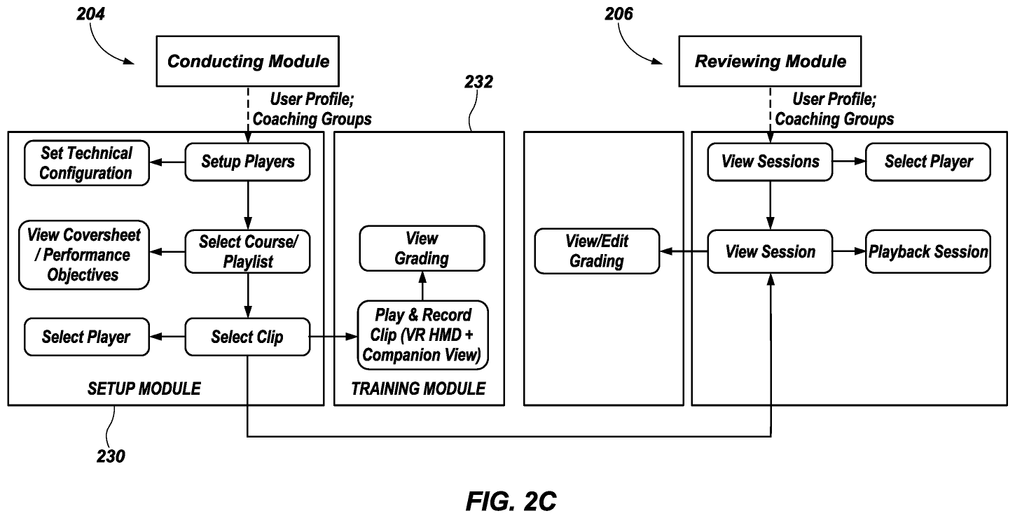

FIG. 2A shows a flowchart for accessing a situational evaluation training system (SETS) website or application and implementing a SETS training session. The coach or trainee is directed to homepage 110. The coach or trainee is the directed to a login 112, via a pop-up, sub-panel, or new webpage, to log into the application or website by using a unique identifier and a unique password associated with the unique identifier. The coach or trainee, after logging in, is then directed to a dashboard 114. The dashboard 114 for the trainee can include a training module 104 to perform one or more training sessions, and a review module 106 to review one or more training sessions. The dashboard 114 for the coach can include a defining module 102 to setup a training course, the training module 104, and the review module 106.

The defining module 102 defines a training course or session. To define the training course, a coach can create training courses, including associated training video clips, performance measures and mark-up used to make the video clip interactive. FIG. 1B shows a block diagram of the defining module 102, which includes a course management module and a mark-up management module.

Within the defining module 102, the coach can view the course management hierarchy, view the courses or modules within the respective hierarchies (e.g., training clips (portions of plays) are a subset of sets (plays), which are a subset of a training course (playbook)), add new training clips or videos, edit training clips (including adding performance measures), mark-up training clips, and edit performance measurements (i.e., data or information to be collected, analyzed, or reported on regarding trainee performance as compared against the mark-ups of the training clip). In one example, the performance measurements can be edited to increase or decrease the amount of data or information used to grade trainee performance. In another example, the performance measurements can be edited to more properly align the grade with the trainee performance, such as when the trainee gives a correct answer that deviates slightly from the mark-up (e.g., brevity code called by the trainee is comparable to, yet not identical to, the brevity code included in the mark-up by the coach). The courses include a list of clips and permit the coach to add new clips.

The course management module permits the coach or trainer to define training courses and associated hierarchy in the course selection (e.g., training clips (portions of plays) are a subset of sets (plays), which are a subset of a training course (playbook)). The course management also attaches a cover sheet and defines grading objectives for a set. The cover sheet can include information about each training session or clip, including, without limitation, performance objectives (i.e., goals associated with the training session). The performance objectives can be changed from training session to training session for the same clip. For example, in a first training session for a quarterback, the performance objective is to identify a hot read based on a defensive alignment and the area from which a blitz can occur. In a second training session, the performance objective is to identify the defensive coverage and possible audibles to be made. The course management also attaches video clips to a training clip.

The mark-up management module defines mark-up in the training video clip at specific times/frames, screen locations, or both. The mark-up management also associates a performance measure with the potential results of trainee interaction with a mark-up and defines the correct responses and time limits for those responses. The mark-up management includes training clip editing and adding a video. An interactive mark-up includes voice tags (invisible, e.g. brevity codes for specific locations that will be matched against trainee speech), text prompts (to present a question and multiple-choice selection), visual highlights (to overlay a shape on the screen as part of text prompt, e.g. to highlight a player or area of the field), point of view tracking (to identify locations where the trainee should be looking toward), the like, or combinations or multiples thereof. The mark-up management includes a mark-up start, which is associated with a video frame, such that the mark-up can be displayed for only that frame (video paused) or for a period of video playback. The mark-up can be include that appears on screen and pauses playback for a pre-determined amount of time. Performance measurements can also be edited.

FIG. 1B shows block diagrams of the conducting module 104 and the reviewing module 106.

The conducting module 104 includes a setup module and a training module. In the setup module, the coach can select participating trainees and select training course or training clips to define practice plan. The coach can also review of the related cover sheet and for the coach to specify any technical configuration (e.g. VR headset connection).

In the training module, the trainee trains with the training clips via a trainee view (e.g., on the headset or immersive system) and the coach can simultaneously view the training via a coach view (e.g., on an external device, including a computer, a smartphone, a laptop, a tablet, or the like). During the training course, the trainee can interact with the mark-up clip using voice input, pointer device input, or both. The trainee responses (e.g., visual, audio, or the like) are captured by the headset, an external device (e.g., microphone, computer, laptop, smartphone, tablet, or the like), or both. The time taken to respond and a timestamp at which each response is provided is also recorded. The coach can pause and resume playback, such as via the external device used by the coach during the coach view. Generally, capturing a training includes retrieving a course, selecting a training clip and retrieving the video, and storing or saving the session, session results, or both.

When the trainee is ready, the coach selects the play button on the video player and the training scenario begins to play simultaneously in the trainee's VR headset and on the coach's SETS video players. The coach has the ability to select the speed of the training scenario to enhance learning. The coach's view displays the view of the trainee with the performance measures displayed on the screen at the physical point of performance. On a panel below the video screen is the grade sheet and voice recognition window that displays the trainee's words as he/she says them after reception by a microphone and processing using an NLP capability. If the trainee says the correct word, the performance measure turns red on the coach's screen and the performance measure is marked as correct on the grade sheet.

With the VR headset on, the trainee waits for the coach to push the play button or the trainee activates the play button through verbal command or an external device, such as a computer, remote controller, or the like. The trainee assumes a body position similar to the one used during the actual performance of the task and holding similar equipment as would be used to complete the training task. There is a 3-second delay and then the scenario begins to play. The trainee sees the virtual world without the performance prompts displayed on the coach's screen. The trainee performs the training task as he/she would in the real world, moving his/her body and using the brevity codes (i.e., cognitive linguistic coding, such as key words, that indicate conceptual understanding, recognition of situational variables, and dynamic decision making) that have been standardized (agreed upon and enumerated) through discussions between the organization and the providers of the system and methods described herein to identify key performance behaviors. When the scenario is completed, the trainee either performs the next training scenario in the training plan or removes the headset and reviews the training session with the coach.

The training clip is provided via a platform that provides a framework that simulates a real-world environment in terms of time, space, and physics. A 3-dimensional environment is generated in which a 360-degree video forms the background display, with the trainee point of view positioned at the origin. The system tracks and records the trainee's head movement, gaze movement, the like, or combinations or multiples thereof, concurrently with the brevity codes called by the trainee. To record the trainee inputs, the headset and microphone transmits the view of the video displayed onto the headset, the called brevity called, or both to an external device. The external device can save the view, brevity code, or both. The view, brevity code, or both can be transmitted via a wired or wireless protocol (e.g., WiFi, Bluetooth, Zigbee, or the like).

For example, as the trainee turns his/her head from the center to the left, the change in view of the training clip is recorded (i.e., showing the change in view from the center to the left). The brevity code called out by the trainee during the training session is recorded and synchronized with the associated the directional view, change in head orientation, or both. As another example, as the trainee looks left and calls out the brevity code associated with the situation occurring to the left, the system records the change in view and the brevity code.

The mark-up can be overlaid on the training clip with one or more mark-ups being placed in different locations in the 3-dimensional environment in which one or more mark-ups are not visible in time or space without the trainee changing the head orientation or moving the gaze. For example, a first mark-up is in the center of the field of view when the trainee's head is facing directly forward. As the trainee turns his/her head 45 degrees to the left, a second mark-up appears. This trains the trainee to look in more than one direction in order to better assess the situation, such as the situation associate with the training clip.

In one example, for the trainee to conduct training, the trainee can download a training session onto the headset, open the training session stored on an external device (and transmitted to the headset via a wired or wireless connection) or the headset, or the like. In another example, when the individual is ready to run a training session, logs into a website or application and opens a training screen.

The training session, and any associated content, appears in the file structure panel in the headset, computer, tablet, or mobile device. The file structure and content are static and cannot be altered by the individual. The files are organized as courses for the trainee to progress from one training block to the next as skill develops. This process facilitates progressive learning with basic skill development provided in the first files and skills building upon each other as the trainee progresses through the training program. After the individual trainee has reached the end of the training program, the application will use an analysis of performance and a training algorithm to recommend future training programs or remedial training. Each training scenario has been marked-up with REPS standardized performance measures and a proprietary brevity code system (described further herein) to facilitate cognitive linguistic coding.

In one example, the screen has a file structure on the right panel and a training plan panel across the bottom of the screen. There is a statistics panel in the lower right corner. The center of the screen is the video player with a video control panel that allows the individual to control the speed of the video, pause, play, and save. The individual drags files or individual training scenarios to the playlist panel to create a training plan. Within the training plan panel, the individual can reorder clips, copy clips, select to play certain clips with a check box, and remove clips from the playlist.

When the trainee is ready, the trainee assumes a body position similar to the one used during the actual performance of the task and holding similar equipment as would be used to complete the training task (such as a ball, bat, tool, device, etc.). The trainee then selects the play button on the video player using a verbal command or an external device (e.g., computer, remote controller, or the like) and after a 3-second delay, the training scenario begins to play. The individual has the ability to select the speed of the training scenario to enhance learning. The trainee sees the virtual world without the performance prompts and performs the training task as the trainee would in the real world, moving the trainee's body and using the brevity codes (cognitive linguistic coding) that have been established by the coach to indicate key performance behaviors (such as by speaking a word or phrase that corresponds to the trainee's recognition of a play, a formation, a situation, a concept, etc.). When the scenario is completed, the trainee either performs the next training scenario in the training plan or removes the headset and reviews the training session and grade sheet.

Once the training session is over, an individual can review the graded training sheet either in the headset, laptop, tablet, or mobile device. The voice recognition program is used to auto-grade the grade sheet (see diagram and voice recognition/grading section). If the trainee performed the task in the manner expected or desired (such as by looking at the correct place in the training VR environment, within the prescribed time window, and using the correct brevity code), then the program checks a box indicating successful performance (or provides other indication of successful completion). Each performance measure also has a box where the individual can subjectively change the score if needed and a text box to record training notes. The application takes the total number of tasks completed correctly and uses a grading algorithm to determine overall performance success or failure on the scenario. The individual has the option to review the training session. When the review feature is selected, the scenario (from the trainee's headset view) is replayed with the audio. After reviewing the training scenario, the individual is able to save the review, delete the review, edit the grade sheet, the like, or combinations or multiples thereof.

The grade can be viewed by the coach, the trainee, or both. The grade is determined based on one or more factors. For example, the trainee responses can also be matched to or compared against expected results. The expected results, such as a brevity code (i.e., cognitive linguistic coding, such as key words, that indicate conceptual understanding, recognition of situational variables, and dynamic decision making), are added to the mark-up by the coach to train the trainee and ensure proper learning by the trainee based on expected, preferred, or anticipated actions.

The review module 106 allows for grade review or editing and session or training playback. The completed training sessions and associated responses can be reviewed by the coach, the trainee, or both. Further evaluations of the results can also be performed. In one example, the review can be performed by the coach and trainee in the same geographical location (e.g., within the same room). In another example the review can be performed by the coach and trainee in different geographical locations (e.g., different rooms, different buildings, different towns, different states, etc.). The review module 106 can access the training session from a remote computing device, such as a server, another computer, or the like, or a cloud service. For example, the coach can review the training session on a computer storing the training session and the trainee can access the training session remotely, such as via a wireless protocol, to review the training session concurrently or simultaneously with the coach. As another example, the coach and the trainee can both access the training sessions from a server while the coach and trainee are location in different geographical locations.

Once the training session is over, the coach and trainee (or the trainee on his/her own if training alone) can review the graded training sheet.

Each performance measure also has a box or field where the coach can subjectively change the score if needed and a text box to record training notes. The subjective grade change allows the coach to make grading more accurate in cases of failure of the voice recognition software to accurately capture the brevity code or in instances where the mark-up performance measure may have been incorrect or multiple answers were possible. The note window allows the coach to document and highlight areas requiring more training or areas the trainee needs to sustain. A trainee can go back to the note section to be reminded of tasks needing further training and development. The application takes the total number of tasks complete correctly and uses a grading algorithm to determine a trainee's overall performance success or failure on the training scenario. The coach and the trainee have an option available to review the training session. When the review function or feature is selected, the scenario (from the trainee's headset view) is replayed with the audio on the coach's screen. After reviewing the training scenario, the coach is able to save the review, delete the review, edit the grade sheet, the like, or combinations or multiples thereof.

The performance can be graded or score by task scoring, overall training scenario grade, threshold scoring, the like, or combinations or multiples thereof. In task scoring, a scoring algorithm calculates the correct or incorrect trainee response and assigns a go/no go grade or a percentage of correctness. In, overall training scenario grade, the scoring algorithm calculates the total correct answers and assigns a categorical grade (e.g., “Trained,” “Needs Practice,” or “Untrained”) based on correct performance of critical tasks, a percentage of correctness, or both. In threshold scoring, the scoring algorithm calculates a percentage threshold of proficiency and assigns a numerical value. The training administrator can set the threshold to make scoring progressive based on skill development. The grading algorithm can provide training suggestions to the coach and to adjust the training plan (e.g., harder or easier) for the trainee.

In one example, the training can be played back. The completed training courses are played back, such as in non-VR mode, on a review device (e.g., a computer, smartphone, laptop, tablet, or the like). The training playback can show mark-up and trainee responses (including audio). The training playback can also pause, rewind, toggle invisible mark-up, play in slow motion, the like, or combinations or multiples thereof. The training playback can also include a pointer or highlight to be overlaid on a screen.

The mark-up can be overlaid on the playback video concurrently with the relevant video frames. In one example, the SETS includes a platform and an engine for rendering and developing the 3-dimensional environment, with the markup, training session recording (including speech capture and recognition) and playback functionality integrated by one or more application programming interfaces (APIs).

For example, the APIs can integrate one or more modules for marking up the video using an editor, which involves placing objects (e.g., brevity codes, text quiz, or tracker tags) 3-dimensional space and synchronizing this with video playback; capturing and recognizing speech, then matching this against markup tags which were visible in the trainee's field of view at the time the speech was said and that they were said in the allowed time period; capturing the speech, head movement, and results from the markup matching from a training session in a proprietary session file; synchronizing one or more captured inputs (e.g., speech, head movement, etc.) by the trainee with video playback to be able to replay the training session; controlling and synchronizing playback between networked client (e.g. Oculus Go) and host (companion PC) applications; calculating and presenting the grading from the markup matching results; managing the course hierarchy, playlist and player selection, including supporting video clip import and clip meta data editing; managing data sharing, data integrity and data persistence; the like; or combinations or multiples thereof.

The performance can be reviewed via feedback. The feedback can be statistical (e.g., values), categorical (e.g., “pass,” “re-do training,” or the like). For example, the results, performance measurements, or both can be returned for the training session. The results can include whether the responses were correct, whether the responses were within an allowable time, the overall grading for the training session, the overall grading for an individual clip, the like, or combinations or multiples thereof. The performance review can recalculate grading by adjustment of results. The performance can also output overall results across a period of time or multiple iterations of a particular course or set.

In one example, the training scenario grade or evaluation record is automatically created by the SETS application. The application takes the performance mark-ups embedded in the training scenario and creates a grade sheet panel below the video screen on the coach's view. The grade sheet scores each performance measure and then assigns an overall grade for the training scenario based on the successful completion of the performance measures embedded in the training scenario.

The SETS application takes the results of each training session and calculates certain statistics. The application keeps a running tally for the trainee on each performance measure and unique training session. The statistics are displayed on the individual's statistics page within the SETS application and the current session's statistics for the individual are displayed on the statistics panel on the individuals training view screen. The application tracks and analyzes individual task performance, overall play scenario grade per defensive categories, time responses per task, and percentage of plays completed successfully in a play series. Statistical relationships are drawn from each measured variable and compared over time, task, session, individual, organization, the like, or combinations or multiples thereof.

In one example, the SETS application uses emerging artificial intelligence (AI) and machine learning (ML) to analyze individual and group performance on specific performance measures. The application then uses this analysis to recommend improvement plans and to suggest to the coach an order of training scenarios for the trainee's skill progression. Table 1 below, describes examples of the types of machine learning used and the unique benefits provided within a virtual training environment.

One or more modules or components of SETS can be incorporated into artificial intelligence or machine learning techniques to obtain or derive one or more output. Machine learning can include supervised learning (SL), unsupervised learning (UL), or reinforcement learning (RL). SL Allows for AI automated recommendations for future training based on data driven predictions. For SL, the data input is analysis and synthesis of brevity code labels spoken during performance. The output is prediction of performance areas needing improvement.

UL allows for automated recommendations of future training by synthesizing unlabeled data with supervised learning and for prediction of performance at a specific level of expertise. For UL, the data input is analysis of unlabeled performance time stamps and visual gaze, and the output is a prediction of trainee's ability to perform a task to standard.

RL allows for automated feedback delivery to reinforce trainee behavior. The input is an analysis of performance criteria and the output a recommendation of concurrent and future training based on performance.

Artificial intelligence creates a fluid, constantly changing environment for the trainee to respond and train based on the outputs of machine learning mentioned in the above section. The data input is machine learning of player movements within the constraints of the environment and rules of the game and the output is a direct independent player movement within the virtual environment.

AR allows the trainees to see their own body and objects in their hands and others training with them in the virtual environment. The input is relational data about the trainee's place in space within the virtual and real environment and objects the trainee is wearing or holding. The output data augments the virtual environment with the actual environment that the trainee is inhabiting, including objects held or worn or co-trainees co-inhabiting the space.

AR creates greater functional equivalence by allowing the trainee to complete a performance task that requires projecting action in the real world to an outcome in the virtual training environment (throwing a ball and having it caught in the VR environment). The input data is relational data associated with the trainee's projection of objects into the virtual environment, including velocity, weight, distant, size, functionality. The output data augments the virtual environment by allowing the trainee to project objects (ball or other object).

After the SETS training scenario is completed, the coach can save the scenario, such as on a storage device or cloud storage, within a file structure created or modified by one or more provides, coaches, or the like. When saving the training scenario, the coach is prompted to enter pre-designated information that allows the training scenario to be sorted and further organized.

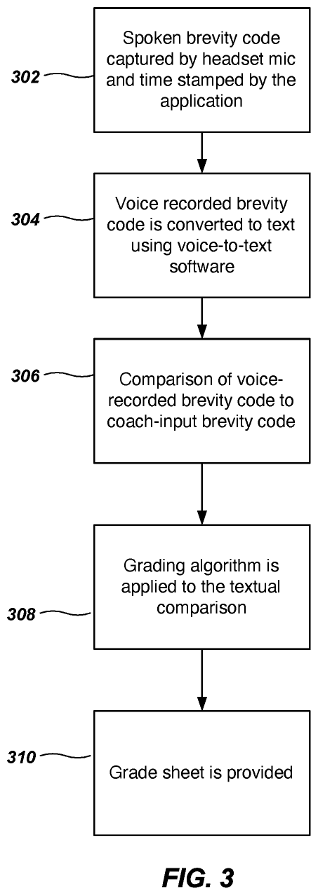

FIG. 3 shows a flowchart for capturing brevity code during a training session and grading the training session. In one example, a voice recognition program is used to auto-grade the grade sheet. The voice recognition software recognizes the text brevity code inputted into the mark-up editor by the coach. During the training session, at 302, when the trainee responds to the VR environment with a brevity code, the voice is captured by the headset's microphone and transmitted to the computer. The trainee's voice is captured using the VR headset audio or the computer's audio, and is then recorded by the SETS app, creating a unique session training file. Next, the captured voice is sent in real time through a Wi-Fi connection to Google voice (or other suitable technology) for translation to text (i.e., speech-to-text translation).

At 304, the voice recorded brevity code is converted to text. The voice data can be sent to Microsoft Windows desktop voice recognition software for translation (again, speech-to-text translation). The Windows desktop voice recognition software allows for the application to run without Wi-Fi on the local host computer; the desktop translation also provides a faster analysis of the spoken word since the data does not have to be transmitted over Wi-Fi to a remote server and back. Google voice recognition provides a larger vocabulary, allowing trainers more choices when selecting brevity codes to match his/her unique performance environment and concepts.

At 306, the voice-recorded brevity code is compared to the coach-input brevity code (e.g., the uttered word is compared with the inputted text brevity code). The SETS application takes the textual response, such as from Google or Windows translation method, and compares it to the coach/trainer inputted text for a performance measure and determines if the voice recognition textual response matches the performance measure text embedded in the training scenario. The voice-recorded brevity code, the converted text response, or both can be transferred via one or more transmission protocols (e.g., wireless or wired). In one example, the SETS application uses voice recognition technology (such as that available via Windows desktop and Google voice) to compare the brevity codes spoken by the trainee to the textual performance measures (i.e., terms, key words, etc.) embedded into the scenario by the coach.

At 308, a grading algorithm is applied to the textual comparison, such as that when the trainee performed the task to the desired standard(s) (e.g., looking at the correct place in the training VR environment, within the prescribed time window, and using the correct brevity code), then the program stores an indication of the successful performance (such as “checking” a box on a report form). Alternatively, an improperly performed results in an unsuccessful grade. At 310, a grade sheet can be provided.

Each performance measure also has a box or field where the coach can subjectively change the score if needed and a text box to record training notes. The subjective grade change allows the coach to make grading more accurate in cases of failure of the voice recognition software to accurately capture the brevity code or in instances where the mark-up performance measure may have been incorrect or multiple answers were possible. The note window allows the coach to document and highlight areas requiring more training or areas the trainee needs to sustain. A trainee can go back to the note section to be reminded of tasks needing further training and development. The application takes the total number of tasks complete correctly and uses a grading algorithm to determine a trainee's overall performance success or failure on the training scenario. The coach and the trainee have an option available to review the training session. When the review function or feature is selected, the scenario (from the trainee's headset view) is replayed with the audio on the coach's screen. After reviewing the training scenario, the coach is able to save the review, delete the review, edit the grade sheet, the like, or combinations or multiples thereof.

The performance can be graded or score by task scoring, overall training scenario grade, threshold scoring, the like, or combinations or multiples thereof. In task scoring, a scoring algorithm calculates the correct or incorrect trainee response and assigns a go/no go grade or a percentage of correctness. In overall training scenario grade, the scoring algorithm calculates the total correct answers and assigns a categorical grade (e.g., “Trained,” “Needs Practice,” or “Untrained”) based on correct performance of critical tasks, a percentage of correctness, or both. In threshold scoring, the scoring algorithm calculates a percentage threshold of proficiency and assigns a numerical value. The training administrator can set the threshold to make scoring progressive based on skill development. The grading algorithm can provide training suggestions to the coach and to adjust the training plan (e.g., harder or easier) for the trainee.

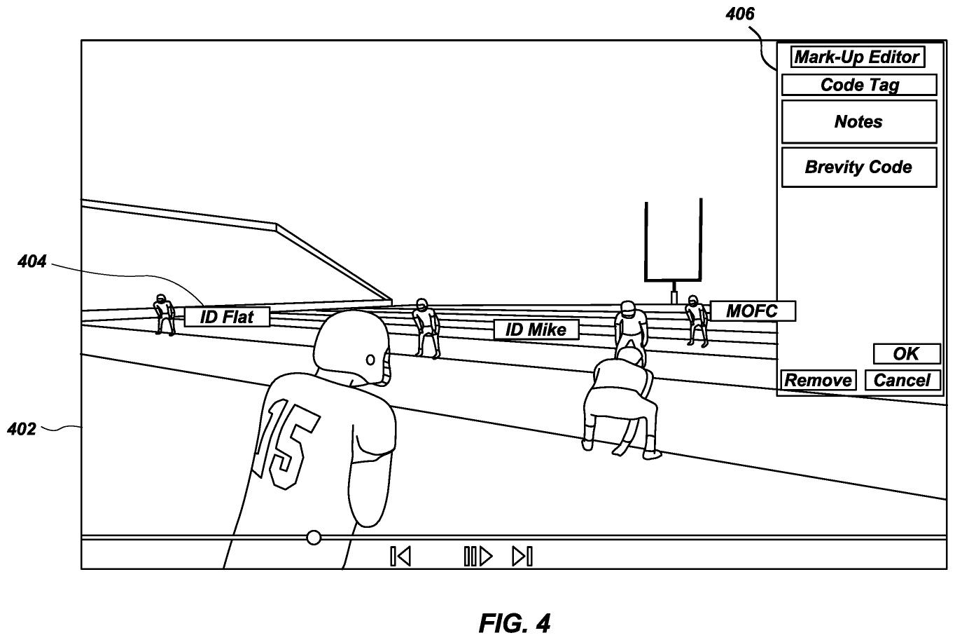

FIG. 4 shows a mark-up editor to create a SETS training scenario. After logging in, the coach uploads game or situational film clips, such as from an external memory (e.g., hard drive, solid state drive, flash drive, or the like), from a camera, from a cloud storage system, or the like, to the mark-up editor or to a training application including the mark-up editor.

The coach then selects a film clip to turn into a SETS training scenario. The selected clip appears on a mark-up device (e.g., computer, laptop, tablet, smartphone, or the like) used by the coach. The coach then creates performance measures 404 in an editor box 406. The editor box 406 can create a performance measure 404 and incorporate a code ID (i.e., a label for the performance measure 404, notes associated with the performance measure, and a desired brevity code or list of appropriate brevity codes).

The performance measures 404 can then be layered over the film clip. The performance measures 404 can be placed at any location in the training clip. The performance measures 404 can be a brevity code or associated with a brevity code. In one example, the performance measure 404 is “ID Flat” and the brevity code is “ID Flat” so that the trainee recognizes that the flat is to be identified. Therefore, when the trainee looks left and says “ID Flat,” the system grades the performance or portion of the performance as “successful” or something comparable. In another example, the performance measure 404 is “ID Flat” and the brevity code is “Flat Man” or “Flat Zone” to indicate the type of coverage in the flat.

There are three types of performance mark-ups that can be used to create a training scenario. The coach can use one or all three types of performance mark-ups on a single film clip. The three types of mark-ups include brevity code mark-up, quiz text mark-up, and gaze tracker mark-up.

Brevity code mark-up allows the coach to assign neurolinguistics performance brevity codes to behavior in the co-inhabited virtual and real environment. The prompt allows the coach to assign a name to the desired behavior, define the activities of the performance behavior, and assign a time limit or time window that the behavior is allowed. Next, the coach marks a location on the clip with his/her mouse to identify the place the trainee must be looking when engaged in the performance behavior and enters the proper brevity code to indicate the desired behavior.

Quiz text mark-up allows the coach to ask multiple choice or yes/no questions based on observed situations in the virtual environment. This mark-up feature also allows the coach to color code certain areas of the field or individual with the VR environment to aid in identifying certain aspects of a trainee's knowledge or behavior. The coach is able to stop the video for a certain time period to allow the trainee to respond to the question.

Gaze tracker mark-up allows the coach to identify a spot or trajectory within the virtual environment that the trainee's gaze should follow during a specific performance behavior. The trainee will not be able to see the mark-up in his/her headset.

The performance measures 404 or mark-ups can be included in a training session, a review session, or both. In one example, the performance measures 404 are included in a play tutorial session to permit the trainee to walk through or learn the play. The performance measures 404 can then be removed or hidden during a testing session. The trainee therefore identifies the performance measures 404 learned in the initial walk through. The performance measures 404 can then be added back or unveiled during the review session. The trainee can review the performance measures 404 to ensure proper or correct responses.

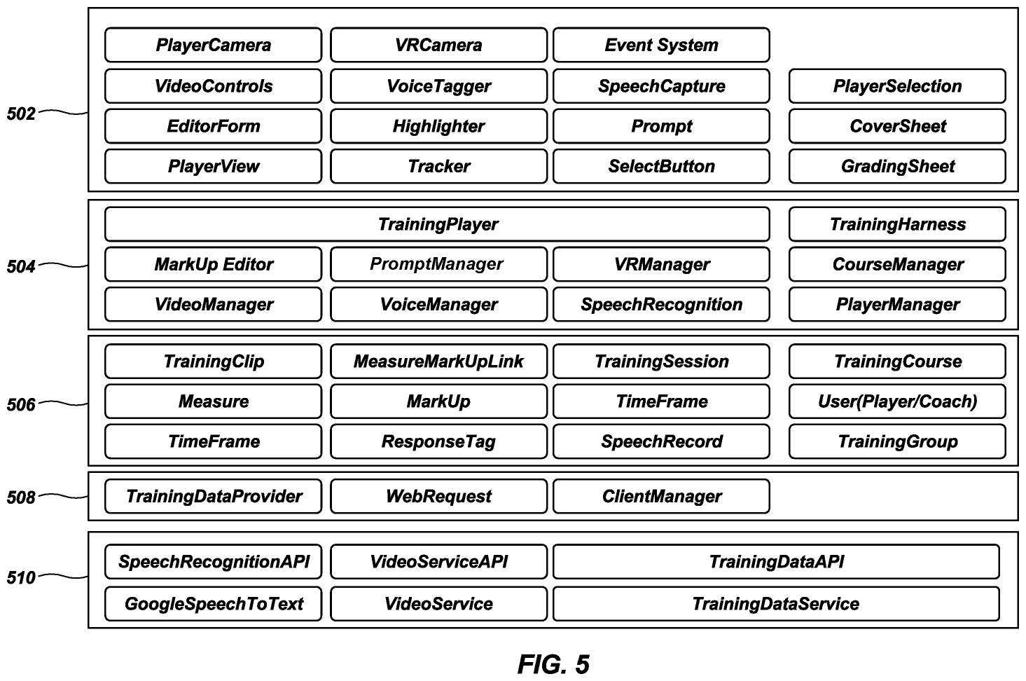

FIG. 5 shows a system including a model view controller and computer design pattern. While the current manifestation of this invention is applied to athletic performance environment, other applied areas include public safety, defense, the trades, and behavioral health. The system includes a trainee interface 502, a controller 504, a data model 506, an integrator 508, and a service 510.

The trainee interface 502 supports trainee interaction via graphical trainee interface and speech recognition. The trainee interface 502 includes rendered video, such as by the 5-dimensional platform, clip mark up, recording of a training session, and grading/playback of a training session.

The trainee interface 502 can also include voice tag and speech capture which time stamps the utterance of word and captures speech for text to voice analysis. The voice tag and speech capture allows for comparison of time and speech against established performance measures inputted using the mark-up editor. The trainee interface 502 also incorporates voice commands, where it is desirous to do so.

The trainee interface 502 includes PlayerView, which is a main controller for GUI canvas-based widgets such as PromptControls and EditorControls; PlayerCamera, which is the camera for the main display for training clip editing and session playback as well as playing training clips on the PC in companion mode; VRCamera, which is the camera for the VR headset display when playing training clips; VideoControls, which controls training clip (e.g., video) playback including play, pause, step forward/back, slow motion and seek; VideoSlider, which supports scrubbing (seek); SpeechCapture, which captures input from the microphone and detects voice; EditorControl, which is a user interface that includes forms and buttons for maintaining MarkUp data; VoiceTagger, which supports creation and display of text prompts in world space; Highlighter, which supports creation and display of shaded polygons in world space; Tracker, which supports creation and display of point of view tracking locations; MMEditButtons, which includes buttons to display and select MarkUp (can also be aligned with video scrubber); PromptControls, which is a user interface that forms and buttons for capturing trainee response and can be displayed in world space to support VR mode; EventSystem, which captures trainee input via keyboard, mouse and other controller devices; GradingSheet, which is user interface for displaying grading scores; PlayerSelection, which is a user interface for selecting trainees for training; CourseEditor, which is a user interface for defining and edition TrainingCourse data; and CoverSheet, which is a user interface for loading and displaying a cover sheet.

The controller 504 supports general business logic and process control flow.

The Controller components are used to communicate data between the View and the Data Model (Model). They take the input from the training session, including speech and persist the data in the Model. The Controller returns the recorded session to the View along with calculating the performance metrics. The Controller calls the Service components to transform speech to text (Google Speech to Text and Windows Speech Recognition).

The controller also includes a markup editor which overlays performance criteria over the VR film and anchors the criteria in time and space. The markup editor allows for the creation of brevity codes, time anchors, space highlights, and gaze tracking to be embedded in the training clip. Allows for the ability to use CLC in an interactive VR training environment for the first time.

The controller 504 includes Training Harness, which provides the overall control layer for accessing training player functionality via the main trainee interface and controls integration; MarkUpEditor, which manages training clip MarkUp definition via EditorForm input as well as VoiceTagger, Highlighter and Tracker components; SpeechRecognition, which manages speech recognition and integration with GoogleSpeechToTextAPI; VideoManager, which wraps the Unity VideoPlayer to control video playback; VRManager, which manages the state of VR Camera and supports head movement emulation in non-VR mode; PlayerManager, which manages trainee selection; and CourseManager, which manages TrainingCourse definition and selection.

The controller 504 also includes TrainingPlayer, which is a main controller for training clip editing, playing/recording and session review. TrainingPlayer also controls training operation state, video playback, editing and prompt management, session playback synchronization and host (PC companion app) synchronization with networked client application (on untethered VR HMD). TrainingPlayer also supports session playback and host synchronization approach is based on standard clip playback with adjustment made based on recorded/client TimeFrame status.

The controller 504 also includes PromptManager, which manages mark-up display and response capture during training clip playback. A PromptManager is created for each MarkUp entity and registers with VoiceManager component to match voice responses against ResponseTags.

The controller 504 also includes VoiceManager, which manages voice recording and speech recognition via SpeechCapture and SpeechRecognition components. VoiceManager also matches recognized speech with ResponseTags and informs related PromptManager.

The data model 506 supports or represents business information entities. The data model 506 components are used to persist the training data. This includes the marked-up video (.clip file), the recorded training session (.sess file), and the individual performance metrics associated with each training session.

The data model 506 also includes time, voice, and gaze measure which captures and measures a trainee's voice tag time, voice response tag, gaze location. The time, voice, and gaze measure interacts with MarkUp and measures data against established performance criteria to produce performance grading output. The data model 506 allows for interaction with the virtual environment and the ability for the first time to use voice and CLC in a time-sensitive dynamic performance environment.

The integrator 508 supports interoperability between application services. The integrator 508 integrates data transfer from multiple web-based provider (voice API, session storage, training overlay associated with video file). The integrator 508 allows for remote storage and access to cloud-based services.

The integrator 508 includes TrainingDataProvider, which provides access to local data storage for training clip and session persistence; WebRequest, which provides support for integration with remote application services via web http protocol; and ClientManager, which supports connectivity and messaging between host (e.g. companion PC app) and client (e.g. untethered VR headset).

The service 508 provide APIs and data management services. The service 508 integrates third party voice to text analysis and allows for measuring accuracy of voice commands against text inputs on the mark-up editor and allows for voice recognition grading. The service can include APIs to provide the external interface to support remote application service integration. The service includes TrainingDataService, which supports training data persistence; VideoService, which supports video content management and session data persistence (since voice recording size may be several megabytes); and GoogleSpeechToText, which supports context-based speech recognition with timings between spoken words to support a high degree of matching accuracy.

In general, an example of the invention can be implemented using a set of software instructions that are designed to be executed by a suitably programmed processing element (such as a CPU, microprocessor, processor, GPU, controller, computing device, etc.). In a complex application or system such instructions are typically arranged into “modules” with each such module typically performing a specific task, process, function, or operation. The entire set of modules can be controlled or coordinated in their operation by an operating system (OS) or other form of organizational platform. Each application module or sub-module can correspond to a particular function, method, process, or operation that is implemented by the module or sub-module. Such function, method, process, or operation can include those used to implement or represent one or more aspects of the inventive system and methods.

For example, an application module or sub-module can contain software instructions, which when executed, cause a system or apparatus to allow coaches to embed text coded performance tasks and draw features over a VR video clip, and be responsive to a performance time horizon/window, anchored geographical space in the VR environment and not alter the base clip; allow the coach to create and save digital training plans within the system; allow the coach to alter aspects of the overlaid performance quickly and without changing the base video clip; capture a trainee's voice and gaze and compare to inputted performance measures; compare voice response with textual input (e.g., a brevity code—receive a trainee's spoken word or phrase, covert that word or phrase to text, compare the text to the code); grade or evaluate trainee behavior based on a set of performance variables (brevity code, gaze, time); capture voice and video for review by coach and trainee; provide coach with ability to override grade sheet and insert notes on the platform; allow for grade sheet to be saved for future review and performance tracking; capture the performance statistics in real-time for individual and groups of trainees; and use ML and AI to develop and recommend future training based on performance and statistical modeling.

The application modules, sub-modules, or both can include any suitable computer-executable code or set of instructions (e.g., as would be executed by a suitably programmed processor, microprocessor, GPU, or CPU), such as computer-executable code corresponding to a programming language. For example, programming language source code can be compiled into computer-executable code. Alternatively, or in addition, the programming language can be an interpreted programming language such as a scripting language.

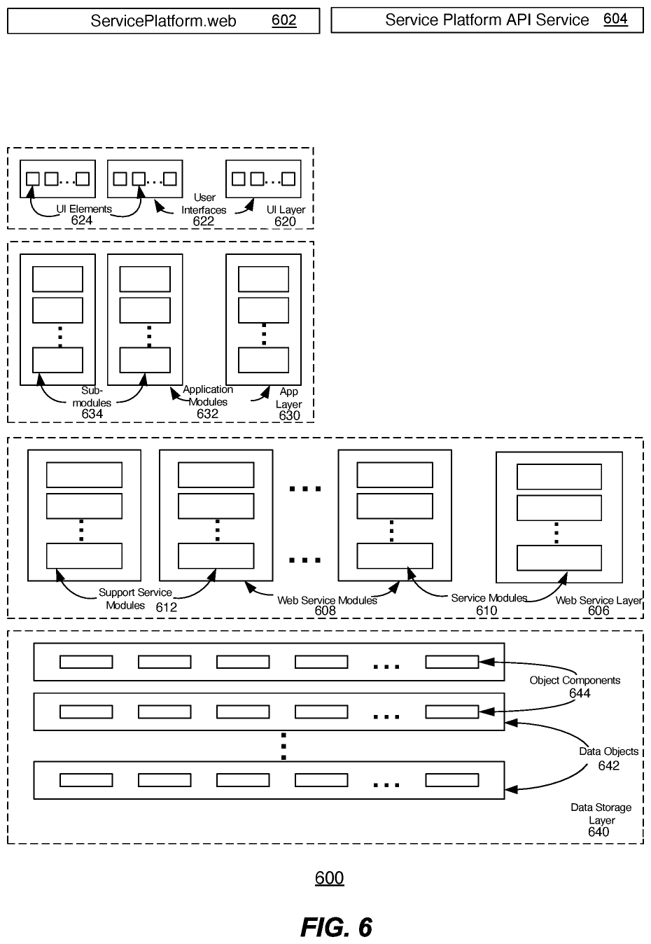

FIG. 6 shows a system architecture 600 for a service platform that can be used in implementing the systems and methods described herein. In some examples, a service platform (a multi-tenant or other “cloud-based” system) which provides access to one or more of data, applications, and data processing capabilities includes a website (ServicePlatform.com), an API (Restful web service), and other support services; the website operation follows a standard MVC (model-view-controller) architecture, including models (i.e., model objects are the parts of the application that implement the logic for the application's data domain. Often, model objects retrieve and store model state in a database. For example, a Bill object might retrieve information from a database, operate on it, and then write updated information back to a Bills table in a SQL Server database); views (i.e., views are the components that display the application's trainee interface (UI). Typically, this UI is created from the model data. An example would be an edit view of a Bills table that displays text boxes, drop-down lists, and check boxes based on the current state of a Bill object); and controllers (i.e., controllers are the components that handle trainee interaction, work with the model, and ultimately select a view to render that displays UI. In an MVC application, the view only displays information; the controller handles and responds to trainee input and interaction. For example, the controller handles query-string values, and passes these values to the model, which in turn might use these values to query the database).

In one example, the Serviceplatform.com (element, component, or process 602, which provides access to one or more of data, applications, and data processing capabilities) is based on a standard MVC architecture, and its controller utilizes the API web service (element, component, or process 604) to interact with the service processes and resources (such as models or data) indirectly. The API web service is composed of web service modules (element, component, or process 608) and one or more that execute an example of the process(es) or functionality disclosed herein, that is a Feature Graph construction and search (or other application) service module (element, component, or process 610). When receiving a request, either directly from a service trainee or from the Serviceplatform.com Controller, the web service module (608) reads data from the input, and launches or instantiates service module (610). Both the Web Service Modules 608 and the Feature Graph Service Modules 610 can be part of a Web Service Layer 606 of the architecture or platform.

The API Service can be implemented in the form of a standard “Restful” web service, where RESTful web services are a way of providing interoperability between computer systems on the Internet. REST-compliant Web services allow requesting systems to access and manipulate textual representations of Web resources using a uniform and predefined set of stateless operations.

The process can be accessed or utilized via either a service platform website 602 or a service platform API 604. The service platform will include one or more processors or other data processing elements, typically implemented as part of a server. The service platform can be implemented as a set of layers or tiers, including a UI layer 620, an application layer 630, a web services layer 606, and a data storage layer 640. Trainee Interface layer 620 can include one or more trainee interfaces 622, with each trainee interface composed of one or more trainee interface elements 624.

Application layer 630 is typically composed of one or more application modules 632, with each application module composed of one or more sub-modules 634. As described herein, each sub-module can represent executable software instructions or code that when executed by a programmed processor, implements a specific function or process.

Thus, each application module 632 or sub-module 634 can correspond to a particular function, method, process, or operation that is implemented by the module or sub-module (e.g., a function, method, process, or operation related to providing certain functionality to a trainee of the platform). Such function, method, process, or operation can include those used to implement one or more aspects of the inventive system and methods, such as by allowing coaches to embed text coded performance tasks and draw features over a VR video clip, and be responsive to a performance time horizon/window, anchored geographical space in the VR environment and not alter the base clip; allowing the coach to create and save digital training plans within the system; allowing the coach to alter aspects of the overlaid performance quickly and without changing the base video clip; capturing a trainee's voice and gaze and compare to inputted performance measures; comparing voice response with textual input (e.g., a brevity code—receive a trainee's spoken word or phrase, covert that word or phrase to text, compare the text to the code); grading or evaluating trainee behavior based on a set of performance variables (brevity code, gaze, time); capturing voice and video for review by coach and trainee; providing coach with ability to override grade sheet and insert notes on the platform; allowing for grade sheet to be saved for future review and performance tracking; capturing the performance statistics in real-time for individual and groups of trainees; and using ML and AI to develop and recommend future training based on performance and statistical modeling.

Note that in addition to the operations or functions listed, an application module 632 or sub-module 634 can contain computer-executable instructions which when executed by a programmed processor to cause a system or apparatus to perform a function related to the operation of the service platform. Such functions can include but are not limited to those related to trainee registration, trainee account management, data security between accounts, the allocation of data processing, storage capabilities, the like, or combinations or multiples thereof, providing access to data sources other than SystemDB (such as ontologies, reference materials, etc.).

The application modules, sub-modules, or both can include any suitable computer-executable code or set of instructions (e.g., as would be executed by a suitably programmed processor, microprocessor, or CPU), such as computer-executable code corresponding to a programming language. For example, programming language source code can be compiled into computer-executable code. Alternatively, or in addition, the programming language can be an interpreted programming language such as a scripting language. Each application server can include each application module. Alternatively, different application servers can include different sets of application modules. Such sets can be disjoint or overlapping.

Similarly, Web service layer 606 can be composed of one or more web service modules 608, again with each module including one or more sub-modules (and with each sub-module representing executable instructions that when executed by a programmed processor, implement a specific function or process). For example, web service modules 608 can include modules or sub-modules used to provide support services (as suggested by support service-modules 612) and to provide the functionality associated with the service and processes described herein (as suggested by Feature Graph Service Modules 610). Thus, in some examples, modules 610 can include software instructions that, when executed, implement one or more of the functions described with reference to the other figures.

Data storage layer 640 can include one or more data objects 642, with each data object composed of one or more object components 644, such as attributes, behaviors, or both. For example, the data objects can correspond to tables of a relational database, and the data object components can correspond to columns or fields of such tables. Alternatively, or in addition, the data objects can correspond to data records having fields and associated services. Alternatively, or in addition, the data objects can correspond to persistent instances of programmatic data objects, such as structures and classes. Each data store in the data storage layer can include each data object. Alternatively, different data stores can include different sets of data objects. Such sets can be disjoint or overlapping.

The architecture of FIG. 6 is an example of a multi-tenant architecture which can be used to provide access to trainees to various data stores and executable applications or functionality (sometimes referred to as providing Software-as-a-Service (SaaS)). Although FIG. 6 and its accompanying description are focused on a service platform for providing the functionality associated with the processes described with reference to FIGS. 1 through 9, note that a more generalized form of a multi-tenant platform can be used that includes the capability to provide other services or functionality. For example, the service provider can also provide a trainee with the ability to conduct certain data analysis, billing, account maintenance, scheduling, etc.

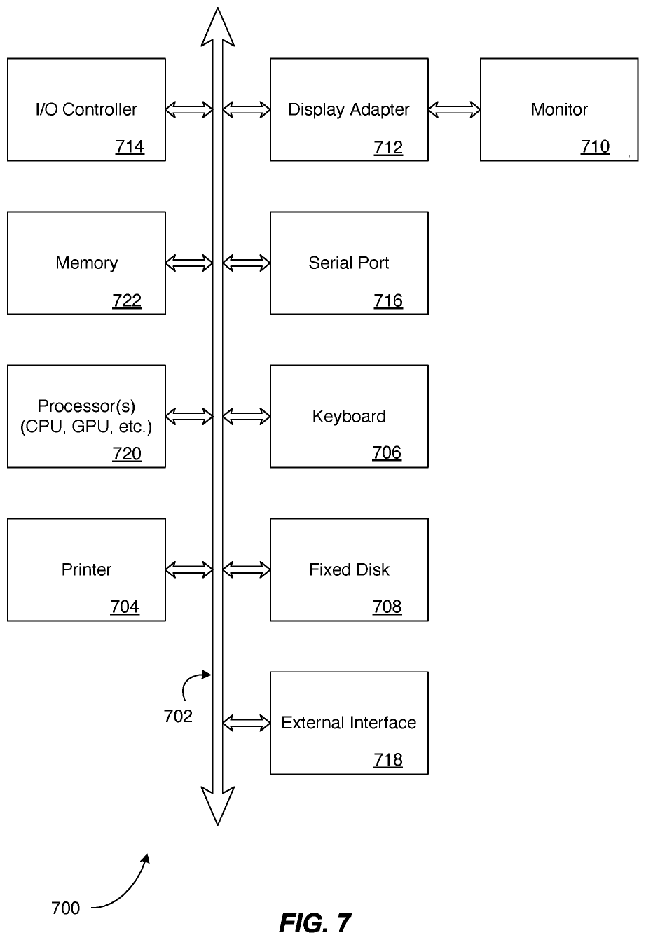

As an example, FIG. 7 is a diagram illustrating elements or components that can be present in a computer device or system 700 configured to implement a method, process, function, or operation in accordance with an example of the invention. The subsystems shown in FIG. 7 are interconnected via a system bus 702. Additional subsystems include a printer 704, a keyboard 706, a fixed disk 708, and a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to further devices or systems not shown in FIG. 4 including a wide area network such as the Internet, a mouse input device, a document scanner, the like, or combinations or multiples thereof. The interconnection via the system bus 702 allows one or more electronic processors 720 to communicate with each subsystem and to control the execution of instructions that can be stored in a system memory 722, the fixed disk 708, or both, as well as the exchange of information between subsystems. The system memory 722, the fixed disk 708, or both can embody a tangible computer-readable medium.

In one example, the methods, processes, function or operations can be implemented as a service for one or more trainees or sets of trainees. In some examples, this service can be provided through the use of a service platform which is operable to provide services for multiple customers, with each customer having a separate account. Such a platform can have an architecture similar to a multi-tenant platform or system, which can be referred to as a SaaS (software-as-a-Service) platform.

Note that the example computing environments depicted in the Figures and described herein are not intended to be limiting examples. Alternatively, or in addition, computing environments in which an embodiment of the invention may be implemented include any suitable system that permits users to provide data to, and access, process, and utilize data stored in a data storage element (e.g., a database) that can be accessed remotely over a network. Further example environments in which an embodiment of the invention may be implemented include devices (including mobile devices), software applications, systems, apparatuses, networks, or other configurable components that may be used by multiple users for data entry, data processing, application execution, data review, etc. and which have user interfaces or user interface components that can be configured to present an interface to a user. Although further examples may reference the example computing environment depicted in the Figures, it will be apparent to one of skill in the art that the examples may be adapted for alternate computing devices, systems, apparatuses, processes, and environments. Note that an embodiment of the inventive methods may be implemented in the form of an application, a sub-routine that is part of a larger application, a “plug-in”, an extension to the functionality of a data processing system or platform, or any other suitable form.

It should be understood that the present invention as described above can be implemented in the form of control logic using computer software in a modular or integrated manner. Based on the disclosure and teachings provided herein, a person of ordinary skill in the art will know and appreciate other ways or methods to implement the present invention using hardware and a combination of hardware and software.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

Any of the software components, processes or functions described in this application may be implemented as software code to be executed by a processor using any suitable computer language such as, for example, Python, Java, JavaScript, C++ or Perl using, for example, conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, to flowcharts or flow diagrams of functions, operations, processes, or methods, or the like. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

Though certain elements, aspects, components or the like are described in relation to one embodiment or example of immersive environment, those elements, aspects, components or the like can be including with any other immersive environments, such as when it desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

What is claimed is:

1. A system for providing an immersive learning environment, the system comprising:
a mark-up editor configured to edit a video or portion thereof with one or more performance measures;
a display device configure to display the video or portion thereof to a trainee; and
one or more processors configured to:
acquire a trainee-input brevity code spoken by the trainee in response to one or more actions associated with the video or portion thereof,
convert the trainee-input brevity code from speech to text,
calculate a trainee performance grade by comparing the trainee-input brevity code converted to text format against the one or more performance measures, and
output the trainee performance grade.

2. The system of claim 1, wherein the display device is an immersive headset.

3. The system of claim 2, further comprising a microphone to perform the acquiring step.

4. The system of claim 3, wherein the microphone is a component of the display device.

5. The system of claim 2, wherein the display device provides 360 degrees field of view.

6. The system of claim 1, wherein the mark-up editor comprises a mark-up editor box to generate the one or more performance measures.

7. The system of claim 6, wherein the mark-up editor is further configured to overlay the one or more performance measures on the video or portion thereof.

8. The system of claim 6, wherein the one or more performance measures comprise a coach-input brevity code.

9. The system of claim 6, wherein the performance measure comprises a quiz-text mark-up or a gaze mark-up.

10. The system of claim 1, wherein the calculating step further comprises comparing a time at which the trainee inputs the trainee-input brevity code against a pre-determined time or time range.

11. The system of claim 1, further comprising a voice-to-text converter to convert the trainee-input brevity code spoken by the trainee into the text format.

12. The system of claim 1, further comprising a review device configured to receive the trainee performance grade.

13. The system of claim 1, wherein the spoken trainee-input brevity code is time-stamped.

14. The system of claim 1, wherein the review device is further configured to replay the video or portion thereof with the one or more performance measures overlaid thereon, with a time-stamped and spoken trainee-input brevity code overlaid thereon, or both.

15. The system of claim 1, wherein the one or more processors is further configured to record a gaze or head orientation of the trainee.

16. The system of claim 15, wherein the calculating step further comprises comparing the gaze or head orientation to one of the performance measures.

17. A method for providing an immersive learning environment, the system comprising:
editing a video or portion thereof with one or more performance measures;
displaying the video or portion thereof to a trainee; and
acquiring a trainee-input brevity code spoken by a trainee in response to one or more actions associated with the video or portion thereof,
converting the trainee-input brevity code from speech to text,
calculating a trainee performance grade by comparing the trainee-input brevity code converted to text format against the one or more performance measures, and
outputting the trainee performance grade.

18. The method of claim 17, wherein the displaying step is performed by an immersive headset.

19. The method of claim 18, wherein the acquiring step is performed by a microphone.

20. The method of claim 17, wherein the microphone is a component of the immersive headset.

21. The method of claim 17, wherein the displaying step is performed within 360 degrees field of view.

22. The method of claim 17, further comprising overlaying the one or more performance measures on the video or portion thereof.

23. The method of claim 22, wherein the one or more performance measures comprise a coach-input brevity code.

24. The method of claim 23, wherein the performance measure comprises a quiz-text mark-up or a gaze mark-up.

25. The method of claim 17, wherein the calculating step further comprises comparing a time at which the trainee inputs the trainee-input brevity code against a pre-determined time or time range.

26. The method of claim 17, wherein the converting step is performed by a voice-to-text converter.

27. The method of claim 17, further comprising time-stamping the trainee-input brevity code at a time of acquisition.

28. The method of claim 17, further comprising replaying the video or portion thereof with the one or more performance measures overlaid thereon, with a time-stamped and spoken trainee-input brevity code overlaid thereon, or both.

29. The method of claim 17, wherein each of the one or more performances measures is overlaid on the video or portion thereof and tagged to a geographical location on the video or portion thereof.
